(19) United States
(12) Patent Application Publication
(10) Pub. No.: US 2011/0222406 A1
(43) Pub. Date: Sep. 15, 2011

(54) Method And Device For Enabling Indication Of Congestion In A Telecommunications Network

(76) Inventors: Fredrik Persson, Marsta (SE); Magnus Hurd, Stockholm (SE); Paul Stjernholm, Lidingo (SE); Lotta Voigt, Bromma (SE)

(21) Appl. No.: 13/128,686

(22) PCT Filed: Nov. 11, 2008
(86) PCT No.: PCT/SE2008/051289

§ 371 Date: May 11, 2011

(51) Int. Cl. H04W 28/12; H04L 12/24

(52) U.S. Cl. 370/236

(57) ABSTRACT

The invention relates to a first communication device arranged to provide congestion indications to a second communication device. The first communication device comprises a control unit arranged to determine to apply an indicating congestion mechanism on a first radio bearer to the second communication device based on a quality of service setting of the first radio bearer. The control unit is further arranged to set a congestion threshold value and a first drop threshold value of a packet buffer associated to the first determined radio bearer. The congestion threshold value indicates that when buffered packets in the packet buffer exceeds the set congestion threshold value the control unit is arranged further to transmit over a transmitting arrangement at least one congestion indication to the second communication device. The first drop threshold value indicates a level of the packet buffer that when buffered packets exceeds the first drop threshold value the control unit is arranged to drop at least one packet.

### TECHNICAL FIELD

The invention relates to method and device within a telecommunications network, in particular, to congestion detection.

### BACKGROUND

In today's cellular or wireless networks there are adaptive applications or transport protocols like TCP that run on top of IP. And due to capacity shortage and/or the like, in the system the transmitting of packets may result in congestion-related packet drops.

When a radio resource function experiences congestion its data buffers increase and, at some point in time, packets are getting discarded. If nothing is done, an implicit congestion notification will be provided to higher layers by experienced packet drops. However, this is not acceptable for several applications, e.g. a video service that would be stalled and the like.

One example for how to notify an application about increased risks for congestion in the network, before congestion happens, is to use the Explicit Congestion Notification (ECN) on the IP layer, where a notification of congestion is indicated in the transmitted packet.

Another existent functionality is to use Active Queue Management, AQM. In AQM there is typically an average time in queue up to which the system is considered stable without congestion (congestion relating to the ability to forward packets, here called T_min); up to that level packets are never dropped. Typically queues do not increase above this level. However, doing so means that the network starts to get congested, and AQM starts to take actions to combat congestion. Packets are then being dropped according to a deterministic scheme or a probabilistic scheme (e.g., Random Early Detection, RED). This behavior is applied up to a second threshold value, here called T_max, above which all packets are being dropped. Normally T_max>T_min (equal values implies effectively AQM inactivated).

Using theses techniques, applications and service flows get the same congestion treatment.

### SUMMARY

Embodiments herein are directed to provide a flexible and efficient manner to enable an application to adapt to load associated to a radio bearer in a telecommunications network.

Embodiments relate to a method in a first communication device within a telecommunications network enabling the indication of congestion to a second communication device. The first communication device determines whether to apply an indicating congestion mechanism on a first radio bearer based on a quality of service setting of the first radio bearer.

The indicating congestion mechanism comprises that the first communication device sets a congestion threshold value of a buffer associated to the determined radio bearer. The congestion threshold value indicates that when buffer load exceeds the congestion threshold value the first communication device transmits at least one congestion indication to the second communication device.

The indicating congestion mechanism also comprises that the first communication device sets a first drop threshold value of the buffer associated to the determined radio bearer. The first drop threshold value indicates that when buffer load exceeds the first drop threshold value the first communication device drops at least one packet in the buffer.

Some embodiments relate to a first communication device for indicating congestion to a second communication device. The first communication device comprises a control unit arranged to determine to apply an indicating congestion mechanism on a first radio bearer to the second communication device based on a quality of service setting of the first radio bearer. The indicating congestion mechanism comprises that the control unit is further arranged to set a congestion threshold value and a first drop threshold value of a packet buffer associated to the first determined radio bearer.

The congestion threshold value indicates that when buffered packets in the packet buffer exceeds the set congestion threshold value the control unit is further arranged to transmit over a transmitting arrangement at least one congestion indication to the second communication device. The first drop threshold value indicates a level of the packet buffer that when buffered packets exceeds the first drop threshold value the control unit is arranged to drop at least one packet.

Embodiments disclose ways for enabling applications to pro-actively adapt to load on a radio bearer, by means of notification signaling based on quality of service setting.

### BRIEF DESCRIPTION OF THE DRAWINGS

Embodiments will now be described in more detail in relation to the enclosed drawings, in which:

FIG. 1 shows a schematic overview of a telecommunications network,

FIG. 2 shows AQM in a cellular network carrying transparent and adaptive IP-based applications,

FIG. 3 shows radio bearers that are based on QCI and ARP, and data over radio bearers are passed down to packet queues in the eNB handled by AQM,

FIG. 4 shows a schematic overview of a first Radio Bearer RB₁ threshold values configuration in an eNB,

FIG. 5 shows a schematic overview of threshold values of a first Radio Bearer of a QoS parameter and a second Radio Bearer of a different QoS parameter in an eNB,

FIG. 6 shows a schematic overview of a combined method and signaling scheme in a telecommunications network,

FIG. 7 shows a schematic overview of a method in a first communication device, and

FIG. 8 shows a schematic overview of a first communication device.

### DETAILED DESCRIPTION OF EMBODIMENTS

Embodiments herein will be described more fully hereinafter with reference to the accompanying drawings, in which embodiments of the solution are shown. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described below with reference to block diagrams and/or flowchart illustrations of methods and devices (systems). It is understood that several blocks of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

FIG. 1 shows a schematic overview of an example of communication devices communicating in a telecommunications network 1. The telecommunications network 1 comprises a first communication device 10, such as a base station, an eNodeB, Radio Network Controller, RNC, and/or the like and a second communication device 20, for example, a first UE, such as a first mobile terminal, a PDA, a mobile phone and/or the like, is camped in the telecommunication network 1. The second communication device is communicating using an application with a third communication device 30, for example, a second UE, such as a second mobile terminal, a server (depicted with dashed lines in FIG. 1), and/or the like.

As the first UE 20 communicates with the second UE 30, data packets are transmitted between the two UEs 20, 30 and in the base station 10 the packets are buffered in a buffer. It should here be understood that AQM buffers may reside in other nodes as well, e.g. in the RNC in UTRAN for the up/downlink and/or the like, before forwarded to the UEs.

The base station 10 notifies the application about increased risks for congestion in the network, before congestion happens, by using the Explicit Congestion Notification (ECN) on the IP layer to the receiving UE 20 (or to UE 30 if UE 30 is the receiving UE). When getting an indication of congestion the application in the receiving first UE 20 can use application layer signaling to ask the sending UE 30 to lower the send rate and by that avoid packet losses. The base station also uses an AQM mechanism that if the buffered packets exceed a first threshold value packets are dropped according a preset scheme. The threshold values of the ECN mechanism and AQM mechanism are set based on one or more Quality of Service QoS parameter/s of a radio bearer carrying the service data.

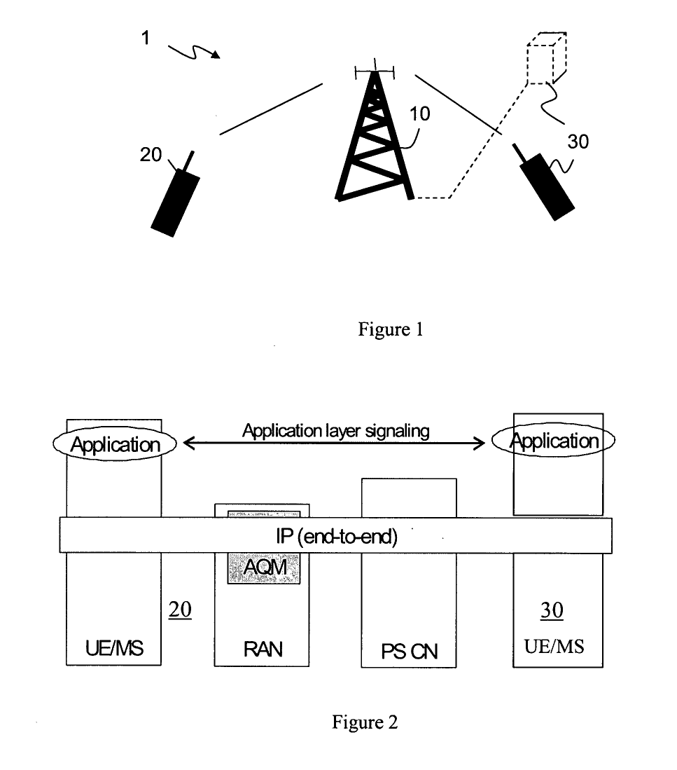

In FIG. 2, an embodiment of signaling data in a cellular network carrying transparent and adaptive IP-based applications is shown. The application is executed between a first UE/MS User Equipment/Mobile Station 20 and a second UE/MS 30. The AQM function is implemented in the RAN, radio access network. The IP data is transmitted through the RAN and through the Packet Switched Core Network PS CN.

Embodiments herein use ECN before congestion happens, on the IP layer to the receiving UE 20. When getting an indication of congestion the application in the receiving first UE 20 can use application layer signaling to ask the sending UE 30 to lower the send rate and by that avoid packet losses. Two bits are set in the Differentiated Services Code Point DSCP field in the IP header, encoding one of four messages.

ECN-awareness is indicated by either of the two first ones, and congestion and not congestion is notified by the third and fourth:
ECN-unaware transport
ECN-aware transport
Congestion experienced
Congestion not experienced

ECN is signaled in the IP header (as shown in FIG. 2 as the end-to-end IP) and is inserted by the base station in the RAN. Note further that it is up to the application to decide on action based on the congestion pre-warning from ECN.

Some adaptive applications can make use of a pre-warning of congestion like given by ECN, e.g., real-time video or TCP-based applications. In the Radio Access Network, ECN is efficiently used in conjunction with AQM.

For most efficient result AQM is to be placed at the bottleneck of the system. In a cellular or wireless network that is typically in connection to the radio interface, see FIG. 2.

In some embodiments, ECN is further set according to a bearer's assigned Quality of Service (QoS) class, e.g. defined by Quality of Service Class Identifier, QCI, and Allocation and Retention Priority, ARP, to decide which bearers shall apply ECN, when to start ECN marking by a set threshold value T_ECN, and when to start dropping packets according to scheme in AQM according to a set threshold value T_min. This relates to systems deploying 3GPP Rel-8 QoS, like E-UTRAN (LTE). A similar mechanism could be based on pre-Rel-8 QoS, using those parameters to distinguish services, such as Traffic Class, Signaling Indication, SI, Traffic Handling Priority, THP, and/or the like.

ECN is an IP level mechanism indicating approaching congestion to the application layer. The application layer is responsible for taking action and decrease source rate (by, e.g., decrease video frame rate, resolution, etc). The advantage of embodiments is to steer which applications shall adapt, and how pro-actively they shall adapt, by means of QoS and ECN.

QCI is used by e.g. mobile communication nodes, or radio access nodes to control bearer level packet forwarding treatment, for example, admission threshold values, queue management threshold values and/or the like. These may be specified by the operator. The Characteristics are standardized and comprises the following elements:
Resource Type (Guaranteed Bit Rate, GBR, or Non-GBR)
Packet Delay Budget
(L2) Packet Error Loss Rate
Priority

The Bearer Type parameter is used for checking if the evolved packet core bearer is associated with an expected guaranteed bit rate or not. The Packet Delay Budget denotes the time that a link layer Service Data Unit (SDU), e.g. an IP packet and/or the like, may reside within the link layer between the first communication device and a UE. The Packet Delay Budget is meant to support the configuration of scheduling and link layer functions. The L2 Packet Error Loss Rate determines the expected maximum rate of non congestion related packet losses. This is for allowing appropriate link layer protocol configurations. Priority is checked to determine priority of the radio bearer.

The ARP is a parameter used to decide whether a radio bearer establishment/modification request may be accepted or rejected, in case of resource limitations like available radio capacity for GBR bearers. It is also used to decide which radio bearers to drop during exceptional resource limitations.

Each radio bearer of a GBR is associated with a Maximum Bit Rate, MBR, QoS parameter. The GBR corresponds to a minimum bit rate to be provided to a GBR bearer and the MBR to an upper limit allowed for a GBR bearer. The MBR may be greater than or equal to GBR for a particular GBR bearer.

Hence, the basic idea of some embodiments is a method that allows the usage of ECN to be based upon QCI and ARP (QCI or QCI+ARP) in the QoS Profile (giving a treatment per bearer in the network):
For which bearers to apply ECN—setting the ECN bits only for certain QCI or QCI+ARP, even if ECN-aware
When to start setting the ECN bits
When to start also dropping packets in AQM

The method is applicable for all 3GPP RATs applying QoS.

ECN is an IP level mechanism indicating approaching congestion to the application layer. The application layer is responsible for taking action and decrease source rate (by, e.g., decrease video frame rate, resolution, etc). The advantage of embodiments herein is to steer which applications shall adapt, and how pro-actively they shall adapt, by means of QoS and ECN.

Without a differentiation between applications and service flows, all applications get the same congestion notification, and can thus decide on decreasing their rates based on that. However, different applications and services act differently on congestion, and may need the notification at different time instances relative to the actual congestion. Also, it may be beneficial primary from an application performance perspective that certain applications do not adapt, down-grade rate, too fast or, that some applications do it before others.

Operators may also want to let certain applications, or applications belonging to certain subscriber groups, be treated differently. Allowing the congestion treatment to depend on the QoS class, e.g. QCI+ARP and/or the like, where QCI is associated with an application and ARP value is associated with a certain subscriber group, provides a means to do the desired differentiation for selected applications/services.

Embodiments aim at providing a method for an early congestion indication by ECN, with possibility to steer the setting of the ECN indication in the IP packets per QoS class (QCI+ARP, SI, THP, and/or the like). Embodiments relate to the usage of ECN in the context of AQM and QoS differentiation using QoS as defined in 3GPP.

For example, 3GPP Rel8 defines an evolved QoS concept to allow RAN to maintain the quality of the provided services. The parameters governing the QoS are listed below.
QoS profile set per bearer
   Quality of service class identifier, QCI
   Guaranteed bit rate, GBR (only GBR bearers)
   Maximum bit rate, MBR (only GBR bearers)
   Allocation retention priority, ARP
QoS per UE for Non-GBR
   Aggregate maximum bit rate, AMBR
QCI Characteristics
   Resource type (i.e. GBR or non-GBR)
   Priority
   Packet Delay Budget, PDB
   Packet Error Loss Rate, PELR

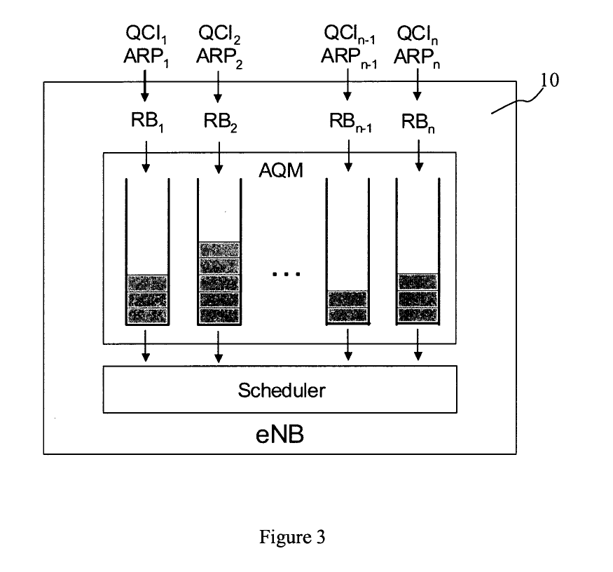

In FIG. 3, a schematic overview of data of radio bearers that are passed down to packet queues in the eNB handled by AQM is shown.

In the eNB 10 each radio bearer is mapped to one packet queue, managed by AQM. The eNB 10 comprises a first radio bearer buffer RB₁ associated with a service with a first QCI₁ and a first ARP₁. Furthermore, a second radio bearer buffer RB₂ associated with a second service with QoS parameters of QCI₂ and APR₂. The eNB 10 comprises a number, n, of radio bearer buffers RBₙ that each comprises QoS parameters QCiₙ and ARPₙ. Furthermore, the illustrated example comprises a radio bearer buffer previous the n-bearer RBₙ₋₁ comprising the QoS parameters QCiₙ₋₁ and ARPₙ₋₁. The packets in the buffers are scheduled to be transmitted through a scheduler. Embodiments herein disclose to provide ECN in the context of AQM and QCI and ARP to obtain a flexible and efficient way of responding to congestion indications. The buffers may be defined in time in buffer, estimated remaining time left in buffer, and/or amount of data present in the buffer and/or the like.

For each queue it is decided the way ECN is applied. The usage of ECN is based upon pairs of QCI and ARP, resulting in a treatment per bearer in the network. The following options are considered per QCI or QCI+ARP:
For which bearers to apply ECN
When to start setting the ECN bits
When to start also dropping packets in AQM

It should be noted that all threshold values may be related to average values.

Different applications and services act differently on packet losses from congestion. For example, data sent over GBR bearers should in normal situations not experience congestion related packet losses, while, for example, the TCP protocol relies on packet losses for its own congestion avoidance mechanism.

It is also possible that different subscriber groups get different treatment, letting budget subscribers/services be degraded at congestion. Premium subscribers/services, on the other hand, are protected and do not experience a quality degradation.

ECN is therefore applied/not applied to a bearer based on QCI or QCI+ARP.

The illustrated example relates to 3GPP Rel-8 QoS, like E-UTRAN (LTE). A similar mechanism could be based on pre-Rel-8 QoS, using those parameters to distinguish services.

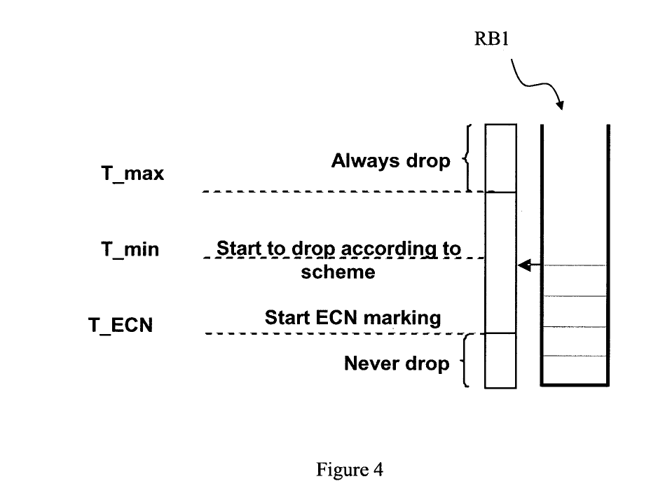

In FIG. 4, a exemplary schematic overview of a first Radio Bearer RB₁ threshold values configuration in an eNB is shown. The RB₁ is associated with a service/application with QoS parameters QCI₁ and ARP₁. A first ECN threshold value T_ECN is set at the RB1 arranged such that if the buffer exceeds the T_ECN value the eNB starts marking an ECN flag in packets and forwards these ECN marked packets to the receiving application.

Furthermore, the RB1 has a first AQM threshold value, T_min, arranged such that if the buffer exceeds this value packets are dropped according to a scheme, for example, every third packet and/or the like. The RB1 buffer also has a second AQM threshold value, T_max, arranged such that if the buffer exceeds this threshold value level all packets are dropped.

As illustrated, the buffer in RB1 exceeds T_ECN but is below T_min, which means that ECN marked packets are transmitted but no packets are dropped.

It may be beneficial primary from an application performance perspective that certain applications do not adapt (down-grade rate) too fast (or, that some applications do it before others).

Operators may want to let certain applications, or applications belonging to certain subscriber groups, react more pro-actively than others. For example, when approaching congestion it may be desired to let premium services/subscribers continue at original source bit rate while budget services/subscribers are indicated to decrease the source bit rate. If not the congestion situation has improved after a determined time, congestion is indicated also to premium services/subscribers.

Also, different applications and services act differently on congestion, and may need the notification at different time instances relative to the actual congestion.

Hence, time to start ECN marking, T_ECN, is set according to QCI or QCI+ARP.

During the time of setting the ECN bits no packets should normally be dropped. The main idea with ECN is to resolve congestion by rate adaptation without implicit congestion notifications by dropped packets. However, if the application does not respond to ECN, or the congestion is not resolved by setting ECN, AQM must start notify the application implicitly by packet drops. This is done by dropping packets according to a certain scheme, may be probabilistic as well as deterministic, starting at the T_min threshold value, note that the ECN marking may continue. As for T_ECN, this T_min threshold value is set according to QCI or QCI+ARP.

T_min and T_ECN may be set independently, but for ECN to start before packets start being dropped, the following relation must be fulfilled (note that the threshold values can be set equal, with the meaning that AQM and/or ECN effectively are disabled):

T_ECN≦T_min≦T_max

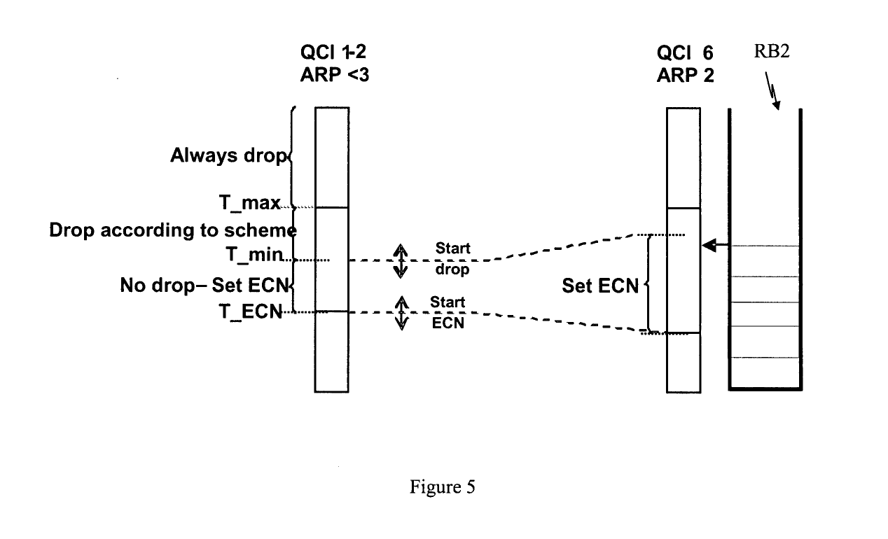

In FIG. 5, an exemplary schematic overview of threshold values of a first Radio Bearer of a QoS parameter and a second Radio Bearer of a different QoS parameter in an eNB is shown.

ECN threshold value is set according to a bearer's assigned QCI and ARP to decide which bearers shall apply ECN, when to start ECN marking by T_ECN, and when to start dropping packets according to scheme in AQM according to T_min.

In the illustrated example, RBs assigned to a QoS of QCI=1−2 and ARP<3 comprises a first T_ECN, a first T_min and a first T_max. RBs assigned to QoS of QCI=6 and ARP=2 comprises a second T_ECN, a second T_min, a second T_max.

The second T_max is equal to the first T_max, but the second T_ECN and T_min differ from the first T_ECN and T_min.

A buffer RB2 of packets at a first level is illustrated and if the buffer is associated to service/application of a QCI=1−2 and ARP<3, ECN marked packets will be transmitted as well as packets will be dropped according to a scheme as the buffer exceeds the first T_ECN and first T_min.

However, if the buffer RB2 at the first level is associated to a service/application/subscriber with a different QoS parameter, in the example, QCI=6 and ARP=2, the eNB will transmit ECN marked packets but will not drop packets according to a scheme.

ECN is an IP level mechanism indicating approaching congestion to the application layer. The application layer is responsible for taking action and decrease source rate by, e.g., decrease video frame rate, resolution, and/or the like. The advantage is to steer which applications shall adapt, and how pro-actively they shall adapt, by means of QoS and ECN.

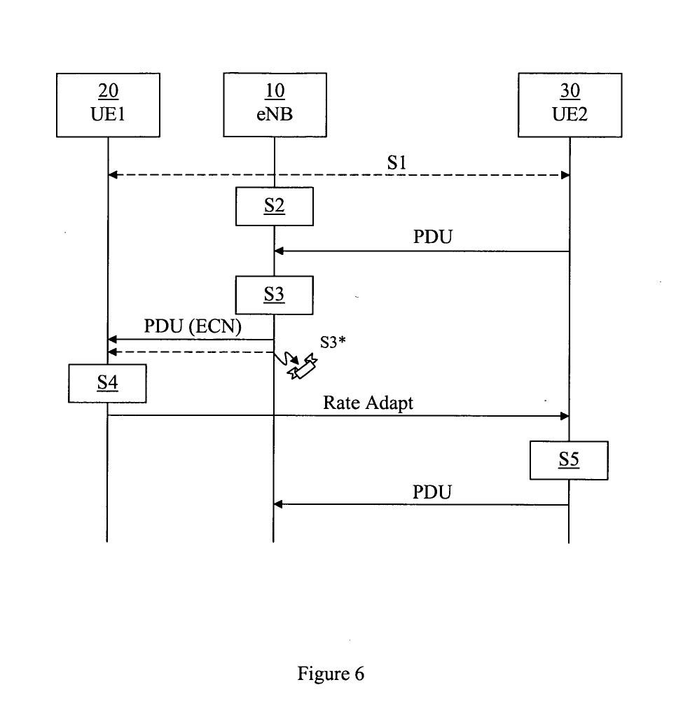

In FIG. 6, a schematic overview of an example of a combined method and signaling scheme in a telecommunications network is shown.

In step S1, a session is set up between a second wireless communication device 20 and a third communication device 30. The second wireless communication device may comprise a user equipment UE and/or the like and the third communication device 30 may comprise a UE, a dedicated server and/or the like.

When setting up a session, in some embodiments, each service data flow is mapped to a QCI (which is a pointer, represented by a single integer number), pointing at an access node-specific configuration that controls the bearer level packet forwarding treatment, and that have been pre-configured by the operator owning the access node.

Each QCI, representing a service or service aggregate, is associated with one set of QCI Characteristics. The QCI Characteristics are used to characterize the configurations of the access nodes. In 3GPP, nine different Standardized QCI Characteristics are being defined, used to ensure interoperability between operators. Besides these Standardized QCI Characteristics, the operator is free to define its own QCI Characteristics, mainly for operation within the operator's own network (since no interoperability is secured through the standard for these).

The operator maps services flows to QoS Profiles, including QCI and ARP, and/or some other parameters. Bearers are set up based on the QoS Profile, where only one pair of QCI and ARP is allowed per bearer.

The QCI gives the operator the possibility to point out a specific service or type of service, for which the operator can specify the desired QoS and apply differentiation. The ARP gives the priority with respect to admission control and bearer-level congestion control. If QCI may point out the service, the ARP may be used to point out the subscriber group. Since an Evolved Packet System EPS bearer (and radio bearer) can be defined only for one pair of QCI and ARP, it is possible to define bearers corresponding to only one single service and subscriber group. E.g., if only one service is mapped to a specific QCI, the radio bearer will also carry only that particular service.

The illustrated example relates to 3GPP Rel-8 QoS, like E-UTRAN (LTE). A similar mechanism could be based on pre-Rel-8 QoS, using those parameters to distinguish services, such as Traffic Class, SI, THP, and/or the like.

In step S2, a first communication device 10 eNB determines whether to apply an indicating congestion mechanism on a first radio bearer based on a quality of service setting of the first radio bearer. That being the case, the buffer related to that service comprises a congestion threshold value above which congestion indications are sent to the second wireless communication device 20, i.e. when load in the buffer exceeds the congestion threshold value, and a first drop threshold value indicating at least one packet to be dropped when load in the buffer exceeds the first drop threshold value.

If a bearer carries several services and it is resource demanding to insert ECN congestion, embodiments provide the possibility to check ECN awareness of the flow before inserting ECN congestion in every packet of the bearer. This requires a separation of flows in the first communication device 10.

The third communication device 30 transmits a number of packet data units PDUs towards the second wireless communication device 20. In the first communication device 10 these PDUs are buffered in a buffer associated to a radio bearer of a QCI and an ARP.

In step S3, the first communication device continuously monitors the buffer comparing the load in the buffer with set threshold values.

As the buffer is building up, the buffer exceeds the congestion threshold value and the first communication device 10 starts marking packets with ECN flags and transmits the marked packets to the second wireless communication device 20.

In step S3*, the buffer continues to build up and exceeds the first drop threshold value and packets are dropped according to a preset scheme.

In step S4, the second wireless communication device receives the ECN marked packets from the first communication device 10 and determines that congestion is indicated. The second communication device transmits a notification to the third communication device in order to reduce the bit rate of the application at the third communication node. And if the second communication device has determined that packets are dropped the amount of the reduction of the bit rate indicated may be increased.

In step S5, the third communication device 30 receives the indication of congestion from the second communication device 20 and adjusts the transmitting rate in accordance in order to avoid congestion.

The third communication device 30 then transmits PDUs in a reduced bit rate towards the second communication device 20.

It should here be understood that the flow of packets may be the opposite. That is, packets may be transmitted from the second communication device to the third communication device and the indicating congestion mechanism may be implemented on packets traveling towards the third communication device, being, for example, a dedicated server and/or the like.

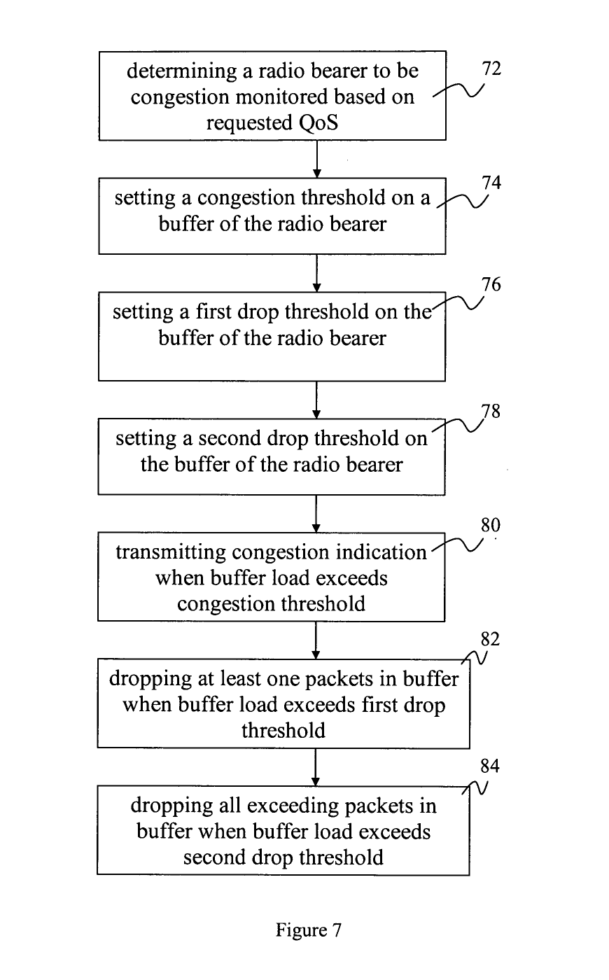

In FIG. 7, a schematic overview of a method in a first communication device is shown.

The first communication device is arranged within a telecommunications network and the method enables the indication of congestion to a second communication device. The second communication device may be a UE, a dedicated server and/or the like.

In step 72, the first communication device determines a radio bearer to be congestion monitored based on requested QoS setting associated to the radio bearer. The QoS parameter may in some embodiments comprise QCI, ARP and QCI, SI, THP, Traffic Class and/or the like.

In step 74, the first communication device, in case the first communication device has determined that the radio bearer is to be congestion monitored/controlled, sets a congestion threshold value of a buffer associated to the determined radio bearer.

In step 76, the first communication device sets a first drop threshold value on the buffer of the radio bearer.

In optional step 78, the first communication device sets a second drop threshold value on the buffer of the radio bearer.

In some embodiments, the drop threshold value/s follows an Active Queue Management, AQM, functionality.

It should be understood that in some embodiments the congestion and drop threshold values are dependent on the QoS setting. For example, different congestion threshold values are set for different QoS, such as QCI and/or the like.

In step 80, the first communication device transmits a congestion indication message to the second communication device if buffered packets in the buffer associated to the radio bearer towards the second communication device exceed the congestion threshold value. It should here be understood that the congestion indication may, in some embodiments, comprise a packet with marked ECN and the marked ECN packet may be transmitted once and/or a plurality of times. The second communication device may be a wireless communication device, a wired dedicated server and/or the like.

In step 82, the first communication device starts to drop at least one packet if buffered packets in the buffer exceed the first drop threshold value. In some embodiments, the packets are dropped according to a preset scheme, such as, every fifth packet and/or the like.

In optional step 84, the first communication device drops all buffered packets that exceed the second drop threshold value in the buffer associated to the radio bearer.

In some embodiments, the congestion threshold value is to be lower than the first drop threshold value. However, the congestion threshold value may in some embodiments be set independently of the drop threshold values.

In order to perform the method a first communication device is provided, such as an eNodeB, RNC, a Network controller node, and/or the like.

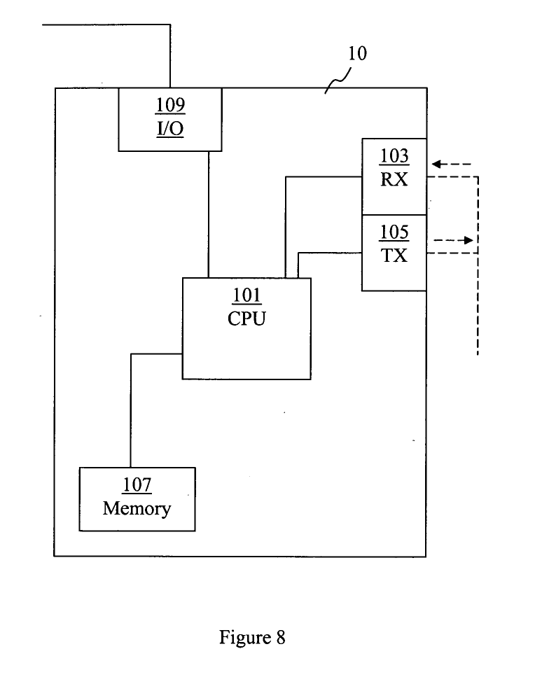

In FIG. 8, a schematic overview of a first communication device is shown.

The first communication device 10 comprises a control unit 101 arranged to determine to apply an indicating congestion mechanism on a first radio bearer to a second communication device based on a quality of service setting of the first radio bearer. That being the case, the control unit 101 is further arranged to set a congestion threshold value of a packet buffer associated to the first determined radio bearer. When buffered packets in the packet buffer exceeds the set congestion threshold value, the control unit 101 is arranged to transmit over a transmitting arrangement 105 at least one indicating congestion message to the second communication device. The transmitting arrangement may comprise, for example, in an eNodeB an antenna, and in an RNC a wired network interface, and/or the like. The second communication device may be a UE, a dedicated server, and/or the like.

Furthermore, the control unit 101 is arranged to set a first drop threshold value of the packet buffer associated to the determined radio bearer. The first drop threshold value indicates a level of the packet buffer that when buffered packets exceed the first drop threshold value the control unit 101 is arranged to drop at least one packet. In some embodiments, the control unit 101 is arranged to drop packets according to a preset dropping scheme when buffered packets exceed the first drop threshold value.

The control unit 101 may in some embodiments further be arranged to set a second drop threshold value of the buffer associated to the determined radio bearer. The second drop threshold value indicates a level of the packet buffer that when buffered packets exceeds the second drop threshold value the control unit 101 is arranged to drop all packets exceeding the second drop threshold value.

In some embodiments, the congestion threshold value is set lower than the first drop threshold value. However, the congestion threshold value may in some embodiments be set independently of the drop threshold values.

The quality of service setting comprises in some embodiments QCI and ARP, QCI, Traffic Class, THP, SI and/or the like.

Load of the buffer may be measured as; time a packet is in buffer, estimated remaining time in the buffer of a packet, amount of packet within the buffer, and/or the like.

The first communication device 10 may further comprise a network interface 109 or a receiving arrangement 103 arranged to receive packets from the second or a third communication device. In the example of the first communication device 10 being an eNodeB, the receiving arrangement 103 comprises a wireless arrangement. The received packets may be stored in buffers in a memory unit 107 of the first communication device. The buffers are associated to the radio bearer of the running service.

The control unit 101 may comprise a CPU, a single processing unit, a plurality of processing units, and/or the like.

The memory unit 107 may comprise a single memory unit, a plurality of memory units, external and/or internal memory units.

Embodiments herein disclose ways to steer which applications shall adapt, and how pro-actively they shall adapt, by means of quality of service and notification signaling.

In the drawings and specification, there have been disclosed exemplary embodiments of the invention. However, many variations and modifications can be made to these embodiments without substantially departing from the principles of the present invention. Accordingly, although specific terms are employed, they are used in a generic and descriptive sense only and not for purposes of limitation, the scope of the invention being defined by the following claims.

1. A method in a first communication device within a telecommunications network enabled to indicate congestion to a second communication device to determine whether to apply an indicating congestion mechanism on a first radio bearer based on a quality of service setting of the first radio bearer, wherein the indicating congestion mechanism performs steps comprising:
setting a congestion threshold value of a buffer associated with the first radio bearer,
transmitting at least one congestion indication to the second communication device when buffered packets in the buffer exceed the congestion threshold value,
setting a first drop threshold value of the buffer associated with the first radio bearer, and
dropping at least one packet when buffered packets in the buffer exceed the first drop threshold value.

2. The method according to claim 1, wherein the quality of service setting comprises one or more of: Quality of Service Class Identifier (QCI), Allocation and Retention Priority (ARP), Traffic Class, Signaling Indication (SI), and Traffic Handling Priority (THP).

3. The method according to claim 1, further comprising the step of setting a second drop threshold value of the buffer associated with the first radio bearer, wherein exceeding the second drop threshold value with buffered packets will initiate dropping of all packets exceeding the second drop threshold value.

4. The method according to claim 1, wherein the dropping of at least one packet exceeding the first drop threshold value follows a dropping scheme.

5. The method according to claim 1, wherein the congestion threshold value is independently set disregarding the first drop threshold value.

6. The method according to claim 1, wherein the congestion threshold value is set lower than the first drop threshold value.

7. The method according to claim 1, wherein the congestion indication comprises a set Explicit Congestion Notification in a packet.

8. The method according to claim 3, wherein the drop threshold values follow an Active Queue Management (AQM) functionality.

9. The method according to claim 1, wherein the set threshold values are dependent on the quality of service setting.

10. A first communication device for indicating congestion to a second communication device, wherein the first communication device comprises a control unit arranged to:
determine to apply an indicating congestion mechanism on a first radio bearer to the second communication device based on a quality of service setting of the first radio bearer; and
set a congestion threshold value and a first drop threshold value of a packet buffer associated with the first radio bearer,
wherein the congestion threshold value indicates that when buffered packets in the packet buffer exceed the set congestion threshold value the control unit is arranged further to transmit over a transmitting arrangement at least one congestion indication to the second communication device and
wherein the first drop threshold value indicates a level of the packet buffer that when buffered packets exceed the first drop threshold value the control unit is arranged to drop at least one packet.

11. The first communication device according to claim 10, wherein the quality of service setting comprises one or more of: Quality of Service Class Identifier (QCI), Allocation and Retention Priority (ARP), Traffic Class, Signaling Indication (SI), and Traffic Handling Priority (THP).

12. The first communication device according to claim 10, wherein the control unit is further arranged to set a second drop threshold value of the buffer associated with the first radio bearer, wherein the second drop threshold value indicates a level of the packet buffer that when buffered packets exceed the second drop threshold value the control unit is arranged to drop all packets exceeding the second drop threshold value.

13. The first communication device according to claim 10, wherein the control unit is arranged to drop the at least one packet following a dropping scheme.

14. The first communication device according to claim 10, wherein the control unit is arranged to set the congestion threshold value independently of the first drop threshold value.

15. The first communication device according to claim 10, wherein the control unit is arranged to set the congestion threshold value lower than the first drop threshold value.

16. The first communication device according to claim 10, wherein the congestion indication is created by the control unit by indicating explicit congestion notification (ECN), in a packet.

17. The first communication device according to claim 12, wherein the drop threshold values follow an Active Queue Management (AQM) functionality.

18. The method according to claim 10, wherein the threshold values are dependent on the quality of service setting.

19. The first communication device according to claim 10, comprising a base station/controller, such as an eNodeB, Radio Network Controller and/or the like.
